(19) United States
(12) Patent Application Publication
(10) Pub. No.: US 2008/0105783 A1
(43) Pub. Date: May 8, 2008

(54) Fuselage design for sonic boom suppression of supersonic aircraft

(75) Inventor: Kelly Laflin, Andover, KS (US)

Correspondence Address: LATHROP & GAGE LC, 2345 GRAND AVENUE, SUITE 2800, KANSAS CITY, MO, 64108, US

(73) Assignee: Cessna Aircraft Company

(21) Appl. No.: 11/592,546

(22) Filed: Nov. 3, 2006

(51) Int. Cl. B64C 1/00

(52) U.S. Cl. 244/1 N; 244/119

(57) ABSTRACT

Disclosed is an aircraft configured to reduce the effects of a sonic boom when flown at supersonic speed. The aircraft has a tapered fuselage. The fuselage has a first predetermined cross-section at a first longitudinal position. The cross section has a horizontal dimension which is greater than the vertical dimension of the cross section. This maximizes off-body pressures to the sides of the aircraft, but mitigates the off-body pressures above and below. This enables the suppression of sonic boom.

### BACKGROUND OF THE INVENTION

1. Field of the Invention

The present invention relates to the field of aircraft fuselage design. More specifically, the present invention relates to fuselage configurations intended to control off-body pressure waves to suppress the sonic boom of supersonic aircraft.

2. Description of the Related Art

As a consequence of the high public annoyance caused by the noise generated by sonic booms, Federal regulations currently prohibit supersonic overland flight by commercial aircraft. Sonic boom suppression of supersonic aircraft is desirable to reduce the offensiveness of the boom, and thereby allow unrestricted supersonic flight overland.

The George-Seebass theory of sonic boom minimization teaches that a cross-sectional area longitudinal distribution (see, e.g., FIG. 1) can be defined that produces a shaped sonic boom at the ground. The shaped sonic boom may be either a “flat-top” (FIG. 2A) or “ramp” (FIG. 2B) both of which generate less noise than an “N-wave” sonic boom (FIG. 2C), which results when an aircraft is not specifically designed for sonic boom suppression.

George-Seebass theory area distributions (SEEB curves) are combinations of area due to aircraft volume and equivalent area due to aircraft generated lift (FIG. 3). Both volume and lift are considered because both influence the pressure field about the aircraft and, thus, the sonic boom. In short, if an aircraft can be configured and shaped in such a way that its pressure field several wing spans away from the aircraft matches the pressure field generated by an axisymmetric SEEB body, then they will produce the same minimized sonic boom at the ground. SEEB curves are routinely used as target longitudinal distributions of cross-sectional equivalent-area (volume plus lift) for designing supersonic aircraft that incorporate sonic boom suppression technology. Obviously, aircraft that match the SEEB curve are not unique. Many aircraft configurations have been derived which may sufficiently match any given SEEB curve.

The George-Seebass theory teaches that to fully minimize sonic boom intensity, the fuselage should be blunt nosed. An example of a typical blunt-nose design is shown in FIG. 4A. Unfortunately, blunt nose configurations produce a large amount of drag. And drag is detrimental to aircraft performance.

One way others have attempted to reduce the drag caused by the fuselage, but still match the SEEB curve is to replace some of the nose volume with lift generated by a canard. FIG. 4B shows one such example where the canard is placed at the very front of the fuselage. While this arrangement may be feasible from aerodynamic, stability, and control standpoints, it also has serious aircraft structural and system implications that limit its practicality.

Other artisans have proposed the incorporation of engine inlets (as seen in FIG. 5A) or channels (as seen in FIG. 5B) at the aircraft nose to create a nose blunting effect while still reducing drag.

Yet another alternative approach proposed teaches that the blunt nose condition, required for sonic-boom minimization, can be relaxed and still yield a shaped sonic boom. One example of such a fuselage design is shown in FIG. 6. The effect of nose-bluntness relaxation results in the desired decrease in drag but at the same time, increases sonic boom intensity, as compared to the original blunt-nosed SEEB body. The FIG. 6 alternative does, however, reduce the off-body pressures to be much less than if no shock suppression technology was applied. Currently, most practical supersonic aircraft designs employing shock suppression technology utilize nose-bluntness relaxation.

Referring to FIG. 7, it may be seen that the theoretical boundary of a sonic boom ground carpet or footprint 702 is defined by a hyperbola created by the intersection of the aircraft initial shock cone impinging on the ground. An under-track 704 is the line on the ground directly below the aircraft, bisecting the hyperbola. The boom is lead by a sudden pressure spike 706 and followed by a pressure drop 708. The sonic boom intensity is generally strongest along the under-track and much weaker at positions laterally nearer the outside footprint boundary (e.g., at position 710). This is because the pressure waves that reach the ground away from the under-track have to travel a longer distance and therefore have more time to decay before impinging on the ground. This can also be seen in FIG. 8 which shows that the boom will be more intense at under track 802 than at laterally distal point 804.

It is known that sonic boom intensity at the ground can be suppressed by configuring aircraft lifting surfaces to reduce strong overpressures along the under-track. The most common implementation of these teachings in supersonic aircraft design with shock suppression technology is the incorporation of significant wing dihedral as shown in FIG. 9.

Others have disclosed that sonic boom suppression can be improved by non-axisymmetrically shaping a fuselage such that it has circular cross-sections, but leaving the fuselage lower centerline flat. An example is shown in FIG. 10.

Several disclosures of sonic boom suppression of supersonic aircraft incorporate the above teachings, unique in their arrangement of aerodynamic surfaces, engine placement, inlet designs and the localized specification of aircraft aerodynamic contours specified to achieve or improve sonic boom suppression.

### SUMMARY OF THE INVENTION

Disclosed is an aircraft configured to reduce the effects of a sonic boom when said aircraft is flown at supersonic speed. The aircraft has a tapered fuselage. The fuselage has a first predetermined cross-section at a first longitudinal position. The cross section has a horizontal dimension which is greater than the vertical dimension of the cross section. This maximizes off-body pressures to the sides of the aircraft, but mitigates the off-body pressures above and below. This enables the suppression of sonic boom.

### BRIEF DESCRIPTION OF THE DRAWINGS

FIG. 1 illustrates a representative George-Seebass cross-sectional area distribution curve for sonic boom minimization.

FIGS. 2A-C illustrate various sonic boom pressure signatures.

FIGS. 3A-C illustrate a representative George-Seebass cross-sectional area distribution curves as a combinations of area due to aircraft volume and lift.

FIGS. 4A-B illustrate prior art aircraft nose geometries for sonic boom suppression.

FIGS. 5A-B illustrate prior art nose inlet configurations for sonic boom suppression and reduced wave drag.

FIG. 6 illustrates a prior art nose-bluntness relaxation embodiment for sonic boom suppression and reduced wave drag.

FIG. 7 illustrates sonic boom ground footprint.

FIG. 8 illustrates pressure ray paths from an aircraft to the ground.

FIG. 9 illustrates a prior art technique of distributing pressure using wing dihedral.

FIG. 10 illustrates a prior art technique of using non-axisymmetric shaping of a fuselage through the addition of fuselage camber.

FIGS. 11A-B illustrate fuselage shaping prior art and the resulting azimuthal distribution of pressure.

FIGS. 12A-B illustrate one embodiment for the fuselage shaping of the present invention and the resulting azimuthal distributions of pressure.

FIGS. 13A-G illustrate a non-inclusive number of alternative cross-sectional shape embodiments which would be suitable for the invention.

FIGS. 14A-C illustrate a non-inclusive collection of cross-sectional shape elongations suitable for the invention.

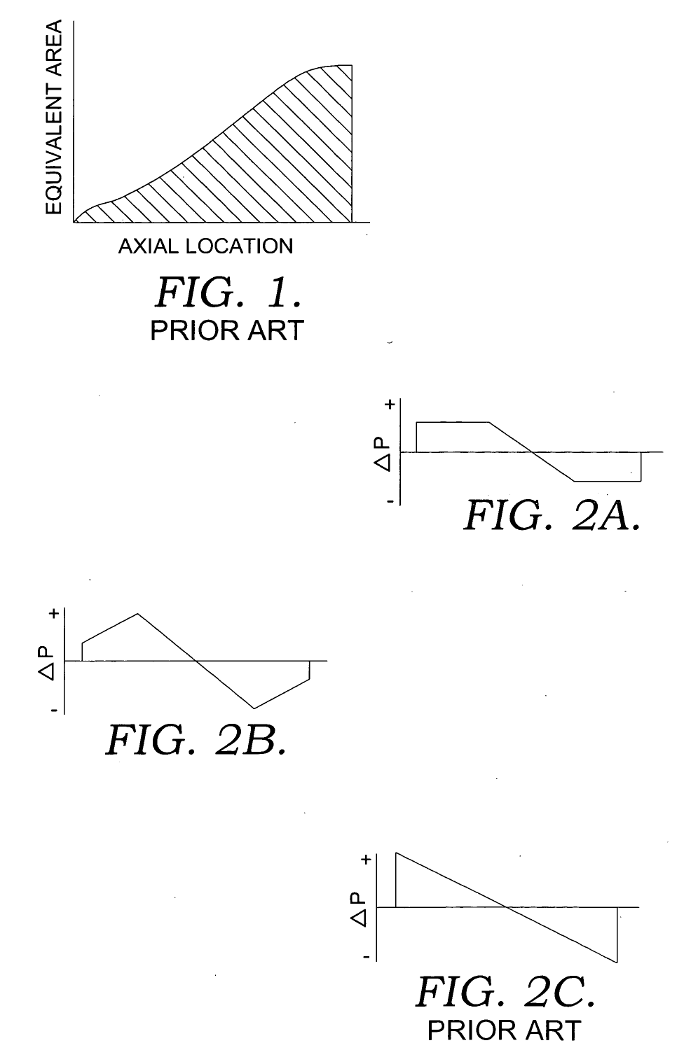

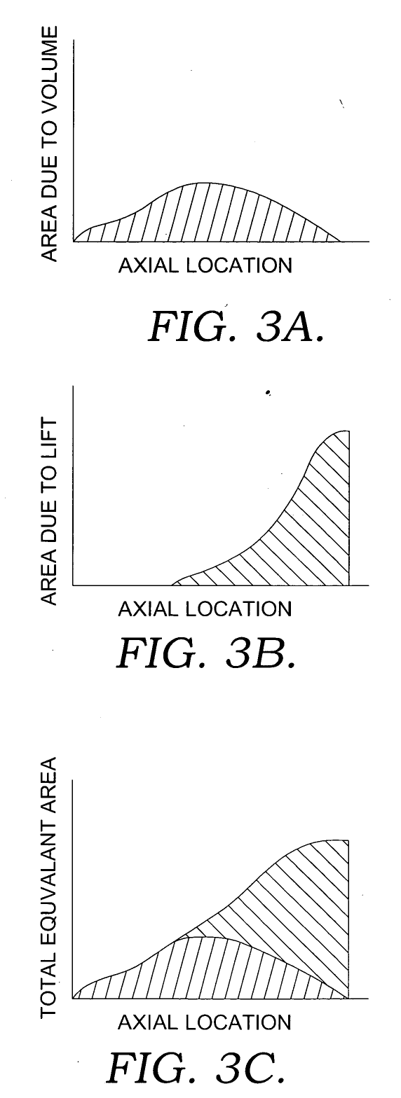

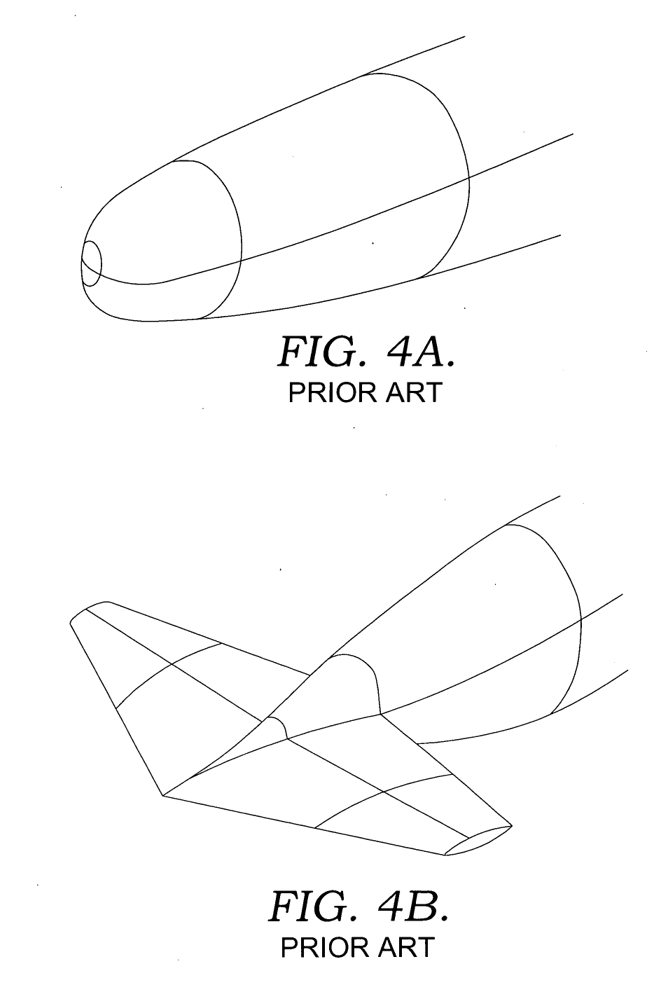

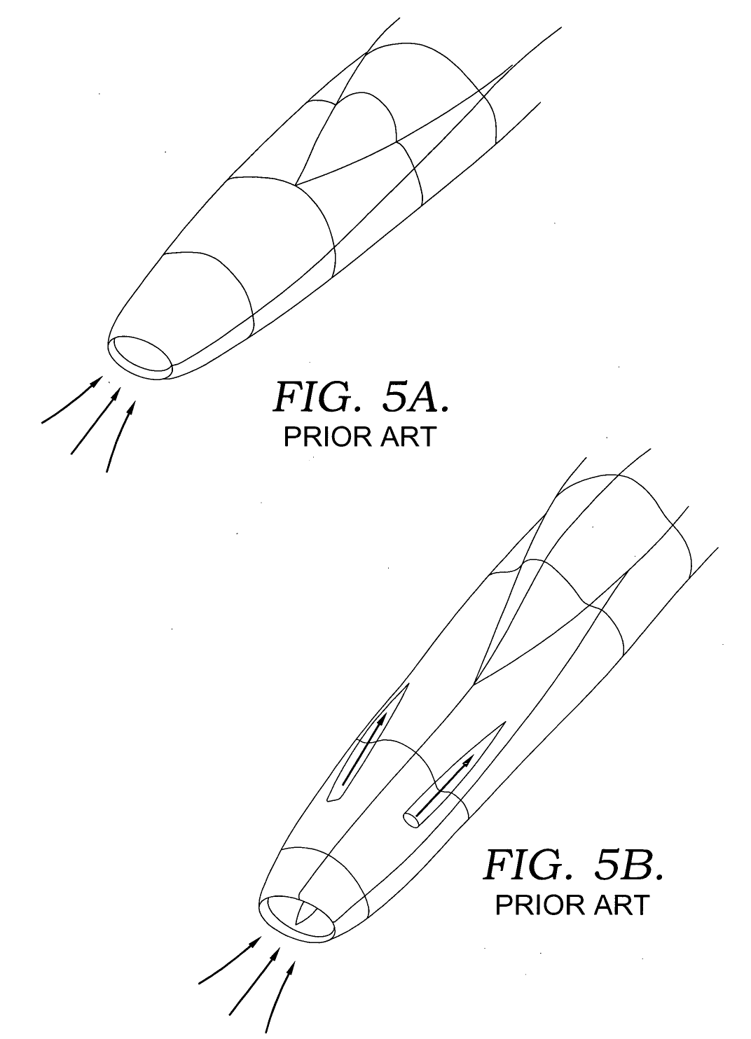

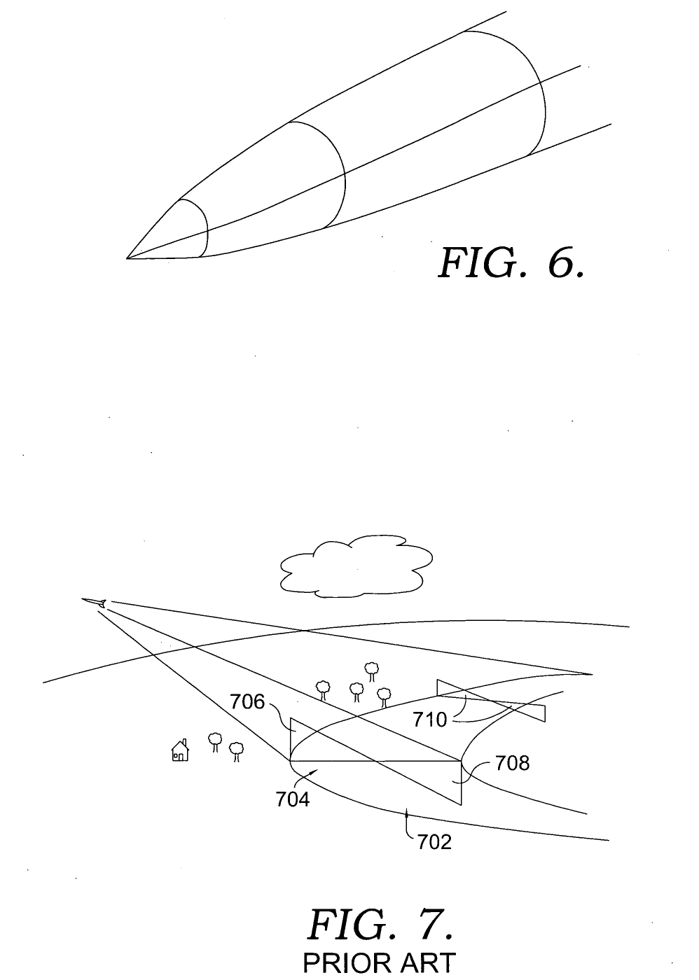

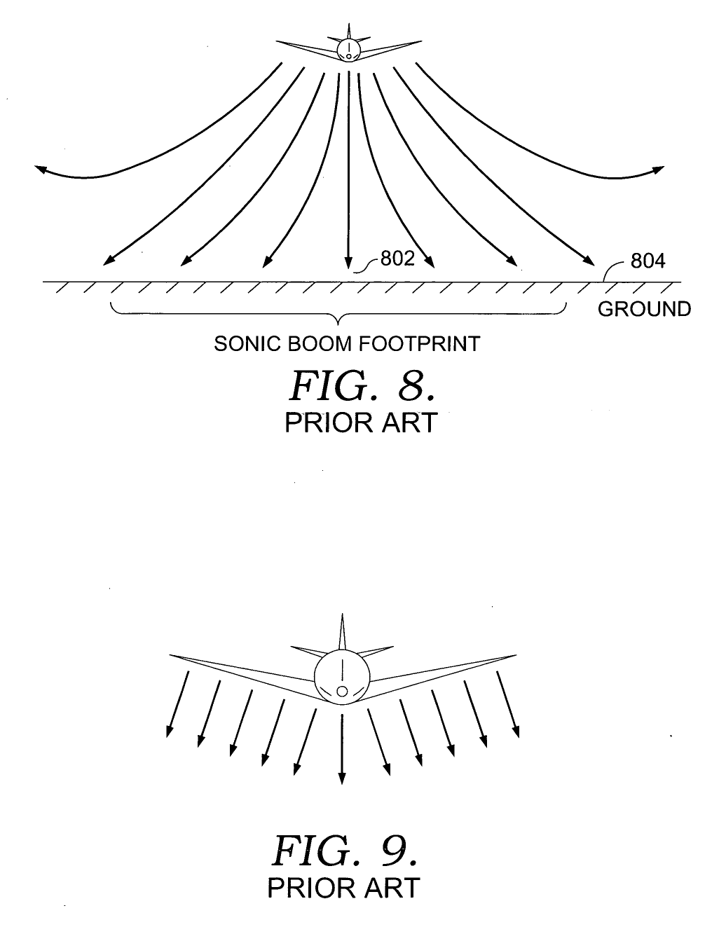

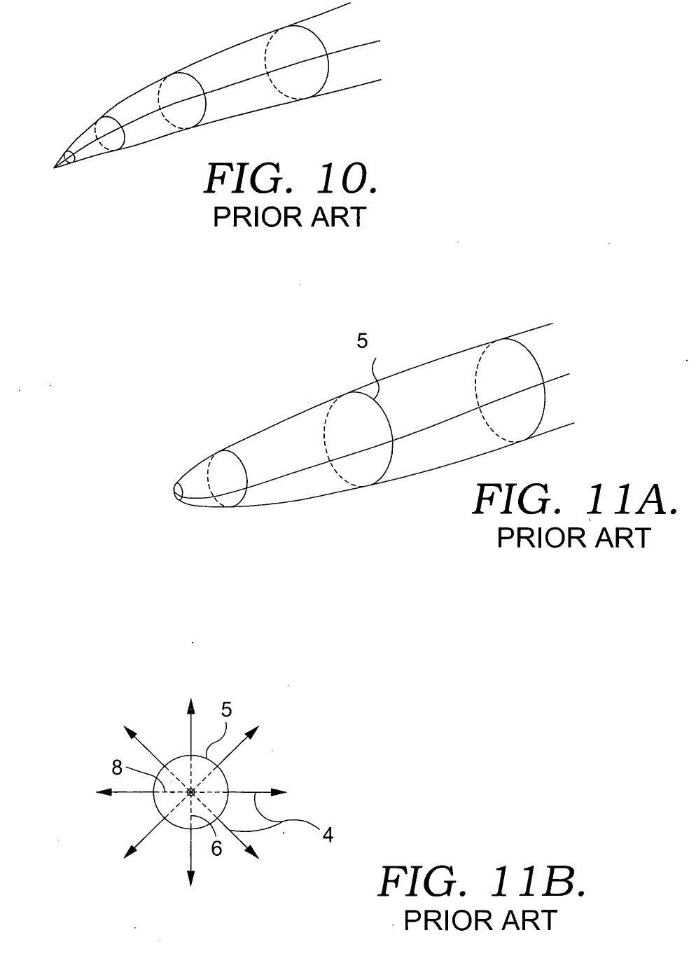

### DETAILED DESCRIPTION OF THE INVENTION

The unique and novel feature of the current invention is the specification of fuselage shape to produce an azimuthal redistribution of pressure for the reduction of sonic boom intensity. In the preferred embodiment, the fuselage is configured such that it is tapered to have cross-sectional area that, when combined with the cross-sectional areas of all other aircraft components as well as the equivalent area due to lift, sufficiently matches a target SEEB curve. The fuselage is comprised of cross sections having horizontal dimensions which are made to be greater than their vertical dimensions. Thus, more of the air that impinges onto the fuselage will be deflected laterally rather than vertically. This maximizes off-body pressures to the sides of the aircraft, but mitigates the off-body pressures above and below.

The result is a reduction in both sonic boom intensity and compressibility drag over the conventional fuselages which have circular-shaped cross sections. Referring back to the prior art designs shown in FIGS. 11A-B, we see that the circular cross sectional shapes which have equal vertical and horizontal dimensions will produce nearly uniform off-body pressures in all directions normal to the surface boundary at any given position. Looking to cross sectional shape 5 in FIG. 11A which has a vertical dimension 6 equal to a horizontal dimension 8 (see FIG. 11B), we also see that the off-body pressure magnitudes 4 (represented in the figure by arrows) are equal at every position.

It has been discovered, however, that if the cross-sectional area is redistributed such that it is elongated in the direction parallel to the ground then the pressure is azimuthally redistributed, smaller overpressures above and below the aircraft, and larger overpressures will be focused in a narrow band to the sides of the aircraft.

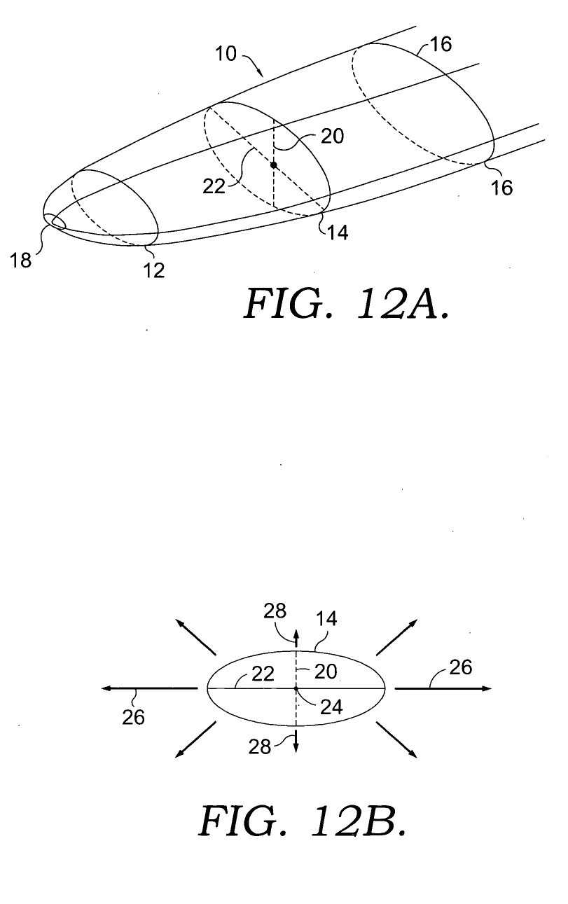

One embodiment of the present invention is shown in FIGS. 12A and 12B. Referring first to FIG. 12A, a fuselage embodiment 10 has progressively widened cross sections 12, 14, and 16 the further you get from a forward end 18 of fuselage 10. Each of cross sections 12, 14 and 16 are wider than they are tall. Cross section 14, e.g., has a horizontal vertical dimension 22 which is greater than its vertical dimension 20 (each referenced from center axis 24).

The disclosed fuselage design comprising horizontal dimensions (in cross section) are increased relative to corresponding vertical dimensions will be incorporated into an overall aircraft design such that the entire aircraft cross sectional area due to volume combined with the equivalent cross sectional area due to lift closely matches a target SEEB curve. This configuration will azimuthally redistribute the pressure over the entire length of the aircraft, allowing for a greatly reduced sonic boom.

The azimuthal redistribution of pressure caused by the fuselage occurs as the aircraft travels through the air at supersonic speeds. When the air impinges upon the fuselage, the deflection of air, and the offbody pressures are greater laterally and minimal vertically. This effect can be seen in FIG. 12B which shows the off-body pressure magnitudes. Unlike the conventional design disclosed in FIG. 11B which shows the design having substantially equal off-body pressure magnitudes, the off-body pressures for the embodiment of the present invention are redistributed such that they are increased laterally and decreased vertically. The greatest off-body pressures will be at straight horizontal (represented by arrows 26) whereas the up and down off-body pressures (represented by arrows 28) are minimized.

The minimization of off-body pressures in the downward direction from the aircraft is obviously advantageous. But this configuration also minimizes the off-body pressures upward. This is beneficial because the upward pressures can reflect downward from the atmosphere. When this happens, the reflected waves can produce a secondary sonic boom that can be heard on the ground several miles to the side of the aircraft.

The disclosed fuselage shaping method is in stark contrast to the common practices of those knowledgeable in the art of supersonic aircraft design. Popular methods and computer codes used in the design of supersonic aircraft, with and without sonic boom suppression, are based on linear theory and assume the fuselage to be a slender body. With these analysis tools, the scientist obtains a longitudinal distribution of aircraft cross-sectional area and then redistributes this area in the form of an axisymmetric body in order to conduct wave drag and sonic boom analyses. This practice of analyzing the aircraft volume as an axisymmetric body is a widely accepted practice, because the commonly held theory teaches that even for nonaxisymmetric slender bodies the pressure disturbances near the Mach cone are essentially axisymmetric. Therefore, it is the common belief that any azimuthal pressure variations near the aircraft will not affect the far-field sonic boom. Consequently, previously disclosed supersonic aircraft designs are dominated by slender fuselages with circular cross-sections as these are the obvious shapes to those practiced in the art. In contrast, the disclosed fuselage shaping method violates the slender body assumption, making it possible to create nonaxisymmetric pressure variations that persist to the far-field; thereby, allowing the sonic boom to be altered through fuselage cross-sectional shape, in addition to cross-sectional area longitudinal distribution.

Some previous disclosers have incorporated non-circular fuselage sections, but not for sonic-boom-suppression purposes. Rather, the irregular design has been for the purpose of integrating a canard, cockpit, cabin, inlets, engines, and wings into the fuselage. But none of these devices manipulate the azimuthal redistribution of pressure for sonic boom suppression purposes.

A further benefit of the invention is the reduction of compressibility or wave drag as the disclosed elongation of the fuselage cross-sectional area tends to weaken the bow shock and reduce the net pressure force acting at the nose of the fuselage. This may improve the overall performance of the aircraft.

Although the embodiment disclosed in FIGS. 12A and B has a substantially oval cross sectional shape, it is important to note that the invention is not limited to one particular cross-sectional shape. One fundamental enabling benefit of the invention is the azimuthal redistribution of pressure through fuselage shaping, obtained principally by elongating the horizontal dimension of the fuselage cross-section, as compared to its vertical dimension. This broad concept would apply to any number of cross-sectional shapes which can be used to produce the desired sonic boom suppression and wave drag reduction objectives.

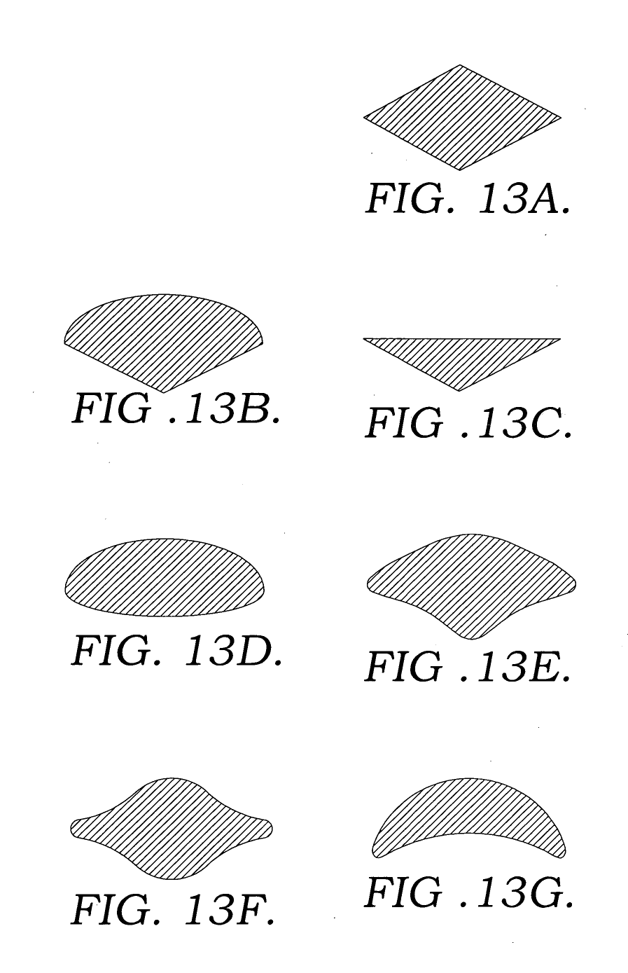

FIGS. 13A-G show alternative embodiments which would also fall within the scope of the present invention. It should be understood that each of FIGS. 13A-G are only a cross sectional view of one portion of a fuselage. One skilled in the art will recognize that the complete fuselage could be tapered from a forward position with gradually increasing cross sections, just like with the FIG. 12A-B embodiment. But one skilled in the art will also recognize that it is not critical to the invention that the cross sections gradually increase. It is possible that in other embodiments the cross sections would not be increased so long as the objectives of the invention were met.

FIG. 13A shows a cross section for a fuselage which has a substantially diamond shaped. Again, the fuselage would begin with small and end with larger substantially diamond cross sectional areas. Similarly, substantially (i) inverted-pie shape of FIG. 13B, (ii) inverted wide triangle shape of FIG. 13C, (iii) offset oval shape of FIG. 13D, (iv) flattened-downwardly extending bicycle seat shape of FIG. 13E, (v) Saturn shape of 13F, and (vi) rotated crescent shaped cross sectional configuration of FIG. 13G. Each of the disclosed cross sectional shapes results in a fuselage which deflects more air laterally than up and down. One skilled in the art will recognize that numerous other embodiments are possible which would also satisfy the objectives of the invention.

It is also possible that the fuselage could transition between different cross sectional arrangements at different positions from the forward end. For example, the fuselage could start off with inverted diamond embodiment of FIG. 13C and then transition into the laterally-extending diamond cross section of 13A.

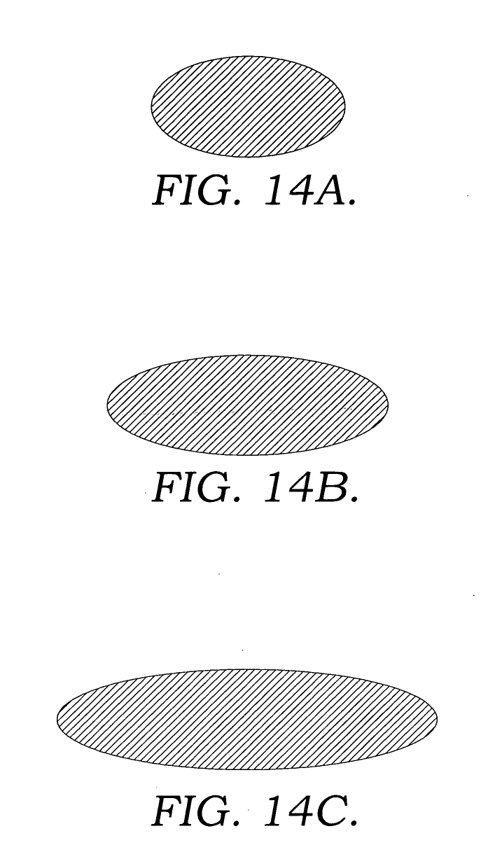

Similarly, the invention does not place bounds on the extent of the horizontal elongation of the cross-sectional shape. FIG. 14A shows an oval cross section from a particular fuselage where the vertical dimension is greater than the horizontal dimension for sonic-boom suppression purposes.

FIG. 14B shows a cross section from a wider and shorter fuselage design. The cross section would be taken at the same distance from the front end of the fuselage as was the FIG. 14A cross section for comparison purposes. The FIG. 14B fuselage has horizontal/vertical dimension ratio which is greater than that disclosed in FIG. 14A.

FIG. 14C shows a third cross section from a third fuselage which is even wider and shorter than the FIG. 14B embodiment. Again, this section would be taken at the same distance from the front end of the fuselage as were the FIGS. 14A and B cross sections. By comparison, it can be seen that the horizontal to vertical ratio would even be lower than for the 14B embodiment. Thus, it is shown that the horizontal to vertical dimensions can be manipulated to meet different design objectives and still fall within the bounds of the present invention.

One skilled in the art will recognize that these boom-suppression principles would also apply to a manned or unmanned supersonic aircraft, missiles, or other devices which travel at supersonic speeds.

It should also be recognized that the fuselage would in many cases have to be also shaped to incorporate components and systems necessary for the aircraft's intended utility and operation, including but not limited to a cockpit, a passenger cabin, wings, a canard, engines, air intake inlets, stabilizing surfaces, and control surfaces.

It will also be evident to those skilled in the art that these technologies could be used separately or in combination with wing dihedral, cambered fuselage, shock deflection, blended wing-body, and other component designs.

As can be seen, the present invention and its equivalents are well-adapted to provide a new and useful apparatus and method of suppressing sonic boom. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out order described.

The invention claimed is:

1. A fuselage for an aircraft, said fuselage configured to reduce the effects of a sonic boom when said aircraft is flown at supersonic speed, said fuselage comprising:
a forward end;
said fuselage having a plurality of cross sections between said forward end and a rearward position; and
each of said cross sections having a vertical dimension and a horizontal dimension, said horizontal dimension being greater than said vertical dimension thus mitigating off-body pressures below said aircraft for the purpose of suppressing sonic boom.

2. The fuselage of claim 1 wherein at least some of said plurality of cross sections are substantially oval.

3. The fuselage of claim 2 wherein substantially all of said plurality of sections are substantially oval.

4. The fuselage of claim 1 wherein at least some of said plurality of cross section are one of: (i) inverted-pie, (ii) inverted diamond, (iii) offset oval, (iv) flattened downwardly extending bicycle seat, (v) Saturn, and (vi) rotated crescent shaped.

5. A method of making a supersonic aircraft, said method comprising:
maximizing off-body pressures above and below said aircraft and minimizing off-body pressures laterally from said aircraft by increasing a plurality of horizontal cross sectional dimensions of a fuselage relative to a plurality of vertical dimensions.

6. The method of claim 5 comprising:
shaping at least a subgroup of said plurality of cross sections to be substantially oval.

7. The method of claim 5 comprising:
shaping substantially all of said plurality of cross sections to be substantially oval.

8. The method of claim 5 comprising:
shaping at least a subgroup of said plurality of cross sections to be substantially: (i) inverted-pie, (ii) inverted diamond, (iii) offset oval, (iv) flattened downwardly extending bicycle seat, (v) Saturn, and (vi) rotated crescent shaped.

9. The method of claim 5 comprising:
shaping substantially all of said plurality of cross sections to be substantially: (i) inverted-pie, (ii) inverted diamond, (iii) offset oval, (iv) flattened downwardly extending bicycle seat, (v) Saturn, and (vi) rotated crescent shaped.

10. A method of minimizing a sonic boom of an aircraft, said method comprising:
tapering a fuselage of said aircraft such that the entire aircraft cross-sectional area due to volume combined with the equivalent cross-sectional area due to lift closely matches a target SEEB curve; and
elongating a horizontal dimension of said fuselage.
